(19) United States
(12) Patent Application Publication
(10) Pub. No.: US 2012/0149272 A1
(43) Pub. Date: Jun. 14, 2012

(54) NON-WOVEN LAYING MACHINE AND A METHOD FOR LAYING A NON-WOVEN FABRIC

(76) Inventor: Hubert Hergeth, Zug (CH)

(21) Appl. No.: 13/211,590

(22) Filed: Aug. 17, 2011

(30) Foreign Application Priority Data
Aug. 18, 2010 (DE) 10 2010 037 777.9

(51) Int. Cl. B32B 5/26; B28B 3/12

(52) U.S. Cl. 442/381; 264/103; 425/366

(57) ABSTRACT

In order to produce air-laid non-woven fabrics with an adjustable strength ratio of the production direction and 90° to the production direction, two non-woven laying machines are set at an angle to the production direction.

### PRIORITY CLAIM

This application claims priority to German application serial number 10 2010 034 777.9 filed on Aug. 18, 2010, which is hereby incorporated by reference in its entirety.

### FIELD OF THE INVENTION

The present invention relates to machines and methods for laying a non-woven fabric, and, more particularly to producing two-layered non-woven fabric with firber orientations in one layer being angled relative to the other layer.

### BACKGROUND OF THE INVENTION

In the non-wovens industry machines have been used to produce non-woven fabrics from staple fibers for almost 100 years. The machines comprise a number of rollers which are provided with clothing and separate the fibers by carding and form a non-woven fabric on a doffer. Normal machines, also called “carding machines”, produce a non-woven fabric that before further strengthening in downstream machines has a distortion resistance ratio in the direction of travel to transverse to the direction of travel of 10:1. By means of random rollers and stuffing rollers according to DIN 64118 the ratio can be improved to 4:1. By means of air-laid non-woven fabrics as in applications DE2535544 and DE 3901313 indicated as examples, this ratio can be improved to 3:1.

A further old method for producing non-woven fabrics is the use of a carding machine with cross layers and optionally a non-woven section. The preferably longitudinally orientated non-woven fabric (in the direction of travel) is fed to a cross layer by means of at least one conveyor belt. This cross layer deposits the non-woven fabric in a number of layers by means of conveyor belts on a depositing belt running at 90° to the draw-off direction. A subsequent non-woven section stretches this non-woven fabric so that approximately 1:1 strength is achieved.

### SUMMARY OF THE INVENTION

This strength should be achieved with the present invention, but with considerably less complexity in machinery.

The complexity in machinery is considerably less. By getting rid of the iridescent movement of the cross layer, according to the invention the speed of the installation is approx. 10 times faster, and the non-woven fabric is more uniform because edges of the layers from which the non-woven fabric is formed are dispensed with.

Further objects of the invention are to improve the strength ratio to 1:1 and to make it adjustable. According to the invention this is achieved by the non-woven forming machine being positioned with its main axes at an angle different to the normal 90° to the direction of travel of the delivery belt.

By depositing the non-woven fabric in the orderly orientation, e.g. by means of a flow of air, the fibers can keep their orientation brought about by the opening, respectively, release rollers when depositing on the depositing belt because no continuous non-woven fabric is deposited. In order to achieve a better transverse rigidity ratio, at least two non-woven laying machines must work together. The strength of the non-woven fabric is achieved by two layers the main fiber alignment of which is displaced by approx. 90°. This leads to high strength in the longitudinal and transverse direction, similarly to by the alignment in a fabric. Conventional non-woven machines try to achieve a good longitudinal/transverse ratio by a random orientation of the fibers (sauerkraut effect). However, with these random orientation the fiber strength is not optimally utilized.

The fibers which are not aligned in the longitudinal or transverse direction only make a small contribution to these strengths.

By means of the adjustability of the angles of the non-woven machine to the conveyor belts, the strength ratios can be set almost infinitely without any major alterations.

On the same installation longitudinally orientated non-woven fabric or non-woven fabric with approximately up to the same longitudinal/transverse strength can be produced in rapid succession.

In order to achieve good depositing, the suction boxes beneath the conveyor belt or suction rollers are also pivoted when the non-woven machine is pivoted, or the opening slot of the suction box is also adjusted.

An opening that is too large for all of the adjustment positions would prevent precise depositing of the fibers due to uncontrolled air flows.

### BRIEF DESCRIPTION OF THE DRAWINGS

Preferred and alternative examples of the present invention are described in detail below with reference to the following drawings:

FIG. 1 shows the conveyance system with the fabric oriented at 90 degrees to the conveyance; and

FIG. 2 illustrates an angled conveyance system of the present invention.

### DETAILED DESCRIPTION OF THE PREFERRED EMBODIMENT

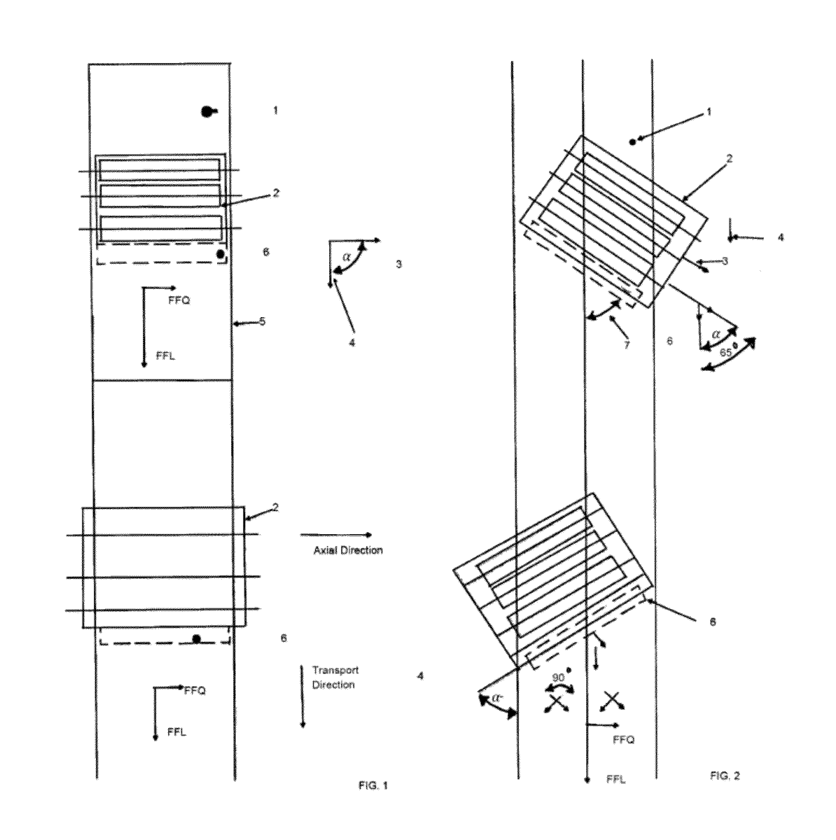

The invention is described by means of two figures. FIG. 1 shows the previous system. A non-woven forming machine 2) is positioned over a circulating delivery belt 1) with the roller with clothing sketched. The axis direction 3) of the rollers with clothing forms an angle of approximately 90° to the direction of travel of the delivery belt 1). The non-woven distortion resistance is approximately three times as great in the direction of travel FFL as transversely to the direction of travel FFQ. A number of machines one behind the other can also deliver to the same delivery system which can also comprise a number of belts or screen belts.

With a screen belt there are suction devices 6) for the fibers between the feed and return of the screen belt.

FIG. 2 shows this type of installation in an embodiment according to the invention.

The non-woven forming machines are disposed at a non-right angle a between the axis direction of their rollers with clothing and the direction of travel of the delivery system. After opening the fibers by a drum with steel clothing or pins the non-woven machine transfers the fibers to a flow of air which deposits the fibers on a screen belt or a screening drum and thus forms the non-woven fabric.

The delivery system 1), here preferably in the form of a screen belt runs in the direction of conveyance 4). Suction boxes 6) are located beneath the screen belt. The fibers are opened by a non-woven forming machine 2) and conveyed to the screen belt. The axes 3) of the opening rollers are at an angle a) to the direction of conveyance of the delivery system. The suction opening of the suction box 6) is approximately parallel in its longitudinal axis to the axes of the opening rollers of the non-woven forming machine. The long conveyor belt of the conveying system 1) does not have to take over the fibers directly. The fibers can also be taken over by a short suction belt or a suction drum on which the non-woven fabric is formed, and from which the non-woven fabric is then passed onto the long conveyor belt which also takes over the non-woven fabric from a number of non-woven machines.

If a number of non-woven machines deliver to a conveying system, the machines must be arranged at opposing angles to the direction of travel of the conveying system in order to achieve the 1:1 strength ratio. With an air-laying non-woven machine the axes of the opening rollers (also called release rollers) would be at approx. +65° with the first machine and with the second machine at approx. −65° to the direction of travel of the discharge belt. In FIG. 2 these angles are identified by +α and −α. Any separate optional shorter depositing belt for forming the non-woven fabric would be at approximately the same angles. The strength ratio can be adjusted if the non-woven laying machine and the suction box can be set at an angle to the delivery belt. This can be implemented by pivoting about a pivot point. In this simple way a non-woven fabric with adjustable strength ratios of up to 1:1 can be produced.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An installation for forming fiber non-woven fabrics having a machine comprising at least one opening roller for forming non-woven fabric and a delivery system for the formed non-woven fabric, characterized in that the axes of the opening rollers are arranged at an angle of between ±8° and ±80° to the direction of delivery of the formed non-woven fabric.

2. The installation according to claim 1, characterized in that the installation for forming non-woven fabric comprises at least one air-laying machine.

3. The installation according to claim 1, characterized in that at least two machines for forming non-woven fabric deliver to a common conveying system.

4. The machine according to claim 1, characterized in that the axes can be set at an angle to the conveying system, preferably together with the machine.

5. The machine according to claim 1, characterized in that the longitudinal suction opening of the suction boxes runs approximately parallel to the axes of the opening rollers and can preferably be adjusted with the axes.

6. The installation according to claim 1, characterized in that one of at least two machines for forming non-woven fabric is at an angle approximately opposing the other to the direction of delivery.

7. A method for producing a non-woven fabric comprising at least two non-woven fabric layers from staple fibers, characterized in that the fibers of a non-woven fabric layer are orderly deposited and the non-woven fabric layer is formed with a main fiber orientation at an angle to the non-woven fabric discharge direction, and the fibers of a further non-woven fabric layer are deposited orderly, and the non-woven fabric layer is formed with a main fiber orientation at an approximately opposing angle.

8. The method according to claim 7, characterized in that the non-woven fabric has at least two layers which have not been produced by means of a plaiter and of which the direction of the maximum tensile strength in the plane deviates by an angle of more than 20° from one another.

9. The method according to claim 7, characterized in that at least two non-woven forming machines which are provided with rollers with clothing and form at least one non-woven fabric layer from staple fibers, the main fiber orientation of which forms an angle a to the discharge direction of a common non-woven discharge device in the plane, the size of this angle is greater than ±25° and smaller than ±85°, and the angle of the first non-woven forming machines in a first direction (+α) and the angle of the second non-woven forming machine in the opposing direction (−α) deviates from the conveying device.

10. A non-woven fabric produced according to a method according to claim 7, comprising two to four layers of staple fibers, wherein the main fiber orientation of at least two of the layers crosses at an angle of 60-120°.

11. The non-woven fabric according to claim 10, with which the specific weight of the layers is 5-250 g/m².

12. The non-woven fabric according to claim 10, characterized in that it is continuous and has no starting section so that in the non-woven fabric no breaks or starting sections as with a non-woven fabric formed by a cross-layer are to be seen.
